(19) United States
(12) Patent Application Publication
(10) Pub. No.: US 2024/0270610 A1
(43) Pub. Date: Aug. 15, 2024

(54) Method and System of Producing Alkaline Hydrogen-Rich Water with Acidic Oxygen-Rich Water as Byproduct

(71) Applicants: Hien Tu Le, Happy Valley, OR (US); Gia Thanh Tu Le, Happy Valley, OR (US); Triet Tu Le, Portland, OR (US)

(72) Inventors: Hien Tu Le, Happy Valley, OR (US); Gia Thanh Tu Le, Happy Valley, OR (US); Triet Tu Le, Portland, OR (US)

(21) Appl. No.: 18/443,263

(22) Filed: Feb. 15, 2024

Related U.S. Application Data
(60) Provisional application No. 63/485,104, filed on Feb. 15, 2023.

(51) Int. Cl. C02F 1/461

(52) U.S. Cl. CPC C02F 1/4618; C02F 2201/4611; C02F 2201/46115; C02F 2201/46145; C02F 2201/4617; C02F 2209/03; C02F 2209/40

(57) ABSTRACT

A system and a method of producing alkaline hydrogen-rich water with acidic oxygen-rich water as byproduct are disclosed. The method begins by filling a first quantity of source water into a first container portion of an electrolysis container through a first container inlet. A second quantity of source water is also filled into a second container portion of the electrolysis container through a second container inlet. An electrolysis process is then executed between the first quantity of source water and the second quantity of source water with a cathode, an anode, and a semipermeable ion-exchange membrane of the electrolysis container. After the electrolysis process is executed, a quantity of alkaline hydrogen-rich water is released out of the first container portion through a first container outlet of the electrolysis container, while a quantity of acidic oxygen-rich water is released out of the second container portion through a second container outlet.

The current application claims a priority to the U.S. provisional patent application Ser. No. 63/485,104 filed on Feb. 15, 2023.

### FIELD OF THE INVENTION

The present invention relates generally to electrolysis systems and hydrogen production methods. More specifically, the present invention discloses a controlled way of producing alkaline hydrogen-rich water with acidic oxygen-rich water as byproduct using electrolysis.

### BACKGROUND OF THE INVENTION

Hydrogen water is water infused with additional hydrogen molecules that can provide various health benefits when drunk. Hydrogen water has been observed to have antioxidant and anti-inflammatory properties. In addition, hydrogen water has been observed to neutralize harmful free radicals within the body and reduce oxidative stress. Nowadays, hydrogen water can be produced using different production methods. For example, hydrogen water can be produced using an electrolysis process where water is passed over a charged electrode, creating hydrogen and water. Other methods are available that allow for the controlled production of hydrogen water. For example, hydrogen water can be produced by pressurizing hydrogen gas into pure water to create hydrogen-rich water. Another method involves a hydrogen-creating tablet that is dissolved in water to produce hydrogen water. However, these methods result in hydrogen water produced with a very low pH level.

An objective of the present invention is to disclose a new method of producing alkaline hydrogen-rich water with acidic oxygen-rich water as byproduct. The present invention implements an electrolysis system that splits running water into hydrogen and oxygen molecules. The split hydrogen and oxygen molecules are carried separately by different water flows which result in alkaline hydrogen-rich water with acidic oxygen-rich water. Another objective of the present invention is to provide a system for producing alkaline hydrogen-rich water with acidic oxygen-rich water as byproduct that allows the controlled production of the alkaline hydrogen-rich water. The system of the present invention enables the control of the hydrogen concentration and pH level in the produced alkaline hydrogen-rich water by adjusting the flowrate and/or the electrical current in the electrolysis system. Additional features and benefits of the present invention are further discussed in the sections below.

### SUMMARY OF THE INVENTION

The present invention discloses a system and a method of producing alkaline hydrogen-rich water with acidic oxygen-rich water as byproduct. The present invention implements an electrolysis method that utilizes a semipermeable ion-exchange membrane that mostly allows H⁺ protons to pass through and significantly reduces the transport of other ions. H⁺ protons are pulled from the anode side of the electrolysis system to the cathode side to form hydrogen gas, which is dissolved in the water present on the cathode side. On the anode side, the oxygen ions left behind form O₂and O₃ gases, which dissolve in the water present on the anode side. As a result, the oxygen-rich water becomes acidic while the hydrogen-rich becomes basic, also known as alkaline water. The alkaline hydrogen-rich water and the acidic oxygen-rich water are then removed from the electrolysis system through different outlets.

Alkaline hydrogen-rich water has been shown to provide several health benefits to the human body. For example, alkaline hydrogen-rich water increases cell absorption of water compared to normal water, which in turn increases the absorption of hydrogen into the body cells. With the increased absorption capability of hydrogen in alkaline hydrogen-rich water, hydrogen can reach the target cell in higher concentration at faster speed and at a greater therapeutic level. Further, alkaline hydrogen-rich water has been shown to be effective in treating glaucoma, reducing blood sugar level in diabetes, and reducing inflammatory symptoms of autoimmunity problems such as Crohn's disease, rheumatoid arthritis, etc.

### BRIEF DESCRIPTION OF THE DRAWINGS

FIG. 1 is a schematic view showing the overall system of the present invention.

FIG. 2 is a schematic view showing a cathode of an electrolysis system of the present invention, wherein the cathode is shown as a perforated flat piece of metal within an electrolysis container of the electrolysis system.

FIG. 3 is a schematic view showing an anode of an electrolysis system of the present invention, wherein the anode is shown as a perforated flat piece of metal within an electrolysis container of the electrolysis system.

FIG. 4 is a schematic view showing the overall system of the present invention, wherein the electrolysis container of the system is shown including inlet valves.

FIG. 5 is a schematic view showing the overall system of the present invention, wherein the electrolysis container of the system is shown including outlet valves.

FIG. 6 is a schematic view showing the overall system of the present invention, wherein the container inlets of the electrolysis container are shown connected to a reservoir of source water via a pumping mechanism and the respective inlet valves.

FIG. 7 is a schematic view showing the electrical connections and the electronic connections of the system of the present invention, wherein the electrical connections or power signals are shown in dashed lines, and wherein the electronic connections or control signals are shown in solid lines.

FIG. 8 is a schematic view showing the electrolysis container of the system of the present invention equipped with flowmeters, wherein the flowmeters are shown electronically connected to a controller, and wherein the electronic connections or control signals are shown in solid lines.

FIG. 9 is a flowchart showing the overall process of the method of the present invention.

FIG. 10 is a flowchart showing the subprocess of adjusting the flowrate of source water through the first inlet valve.

FIG. 11 is a flowchart showing the subprocess of adjusting the flowrate of source water through the second inlet valve.

FIG. 12 is a flowchart showing the subprocess of adjusting the flowrate of alkaline hydrogen-rich water through the first outlet valve.

FIG. 13 is a flowchart showing the subprocess of adjusting the flowrate of acidic oxygen-rich water through the second outlet valve.

FIG. 14 is a flowchart showing the subprocess of pressurizing the source water inflow into the electrolysis container.

FIG. 15 is a flowchart showing the subprocess of pressurizing the source water flow into the electrolysis container with a pumping mechanism.

FIG. 16 is a flowchart showing the subprocess of regulating the source water flow through a first container portion of the electrolysis container with a first valve and a controller.

FIG. 17 is a flowchart showing the subprocess of monitoring the source water flow through the first container portion with a flowmeter.

FIG. 18 is a flowchart showing the subprocess of regulating the source water flow through the first container portion with the pumping mechanism.

FIG. 19 is a flowchart showing the subprocess of regulating the source water flow through a second container portion of the electrolysis container with a second valve and the controller.

FIG. 20 is a flowchart showing the subprocess of monitoring the source water flow through the second container portion with a flowmeter.

FIG. 21 is a flowchart showing the subprocess of regulating the source water flow through the second container portion with the pumping mechanism.

FIG. 22 is a flowchart showing the subprocess of regulating a DC power supply via the controller.

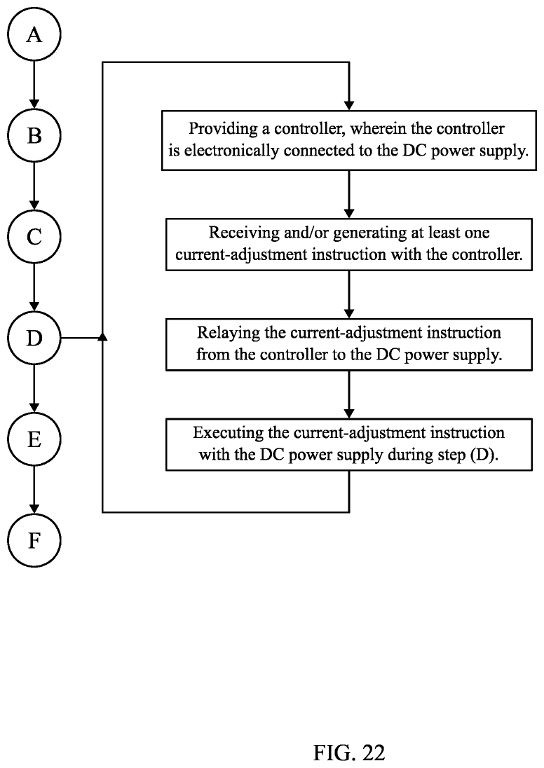

### DETAILED DESCRIPTION OF THE INVENTION

All illustrations of the drawings are for the purpose of describing selected versions of the present invention and are not intended to limit the scope of the present invention.

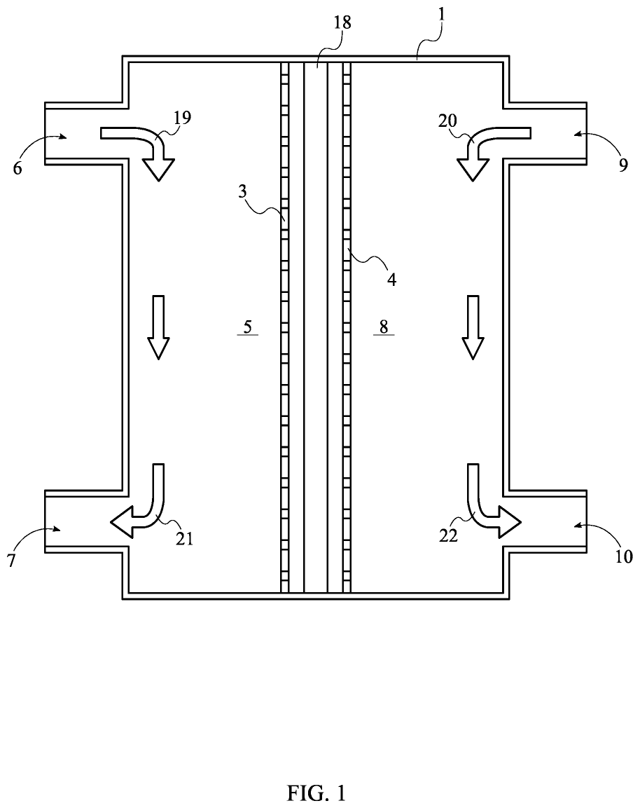

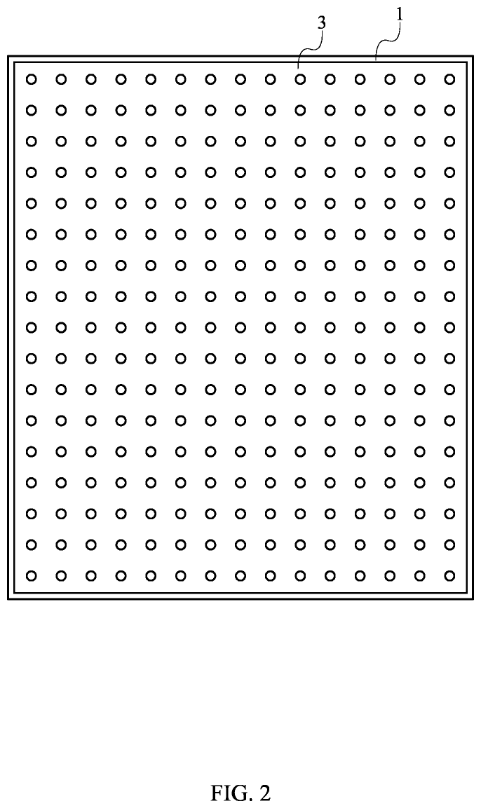

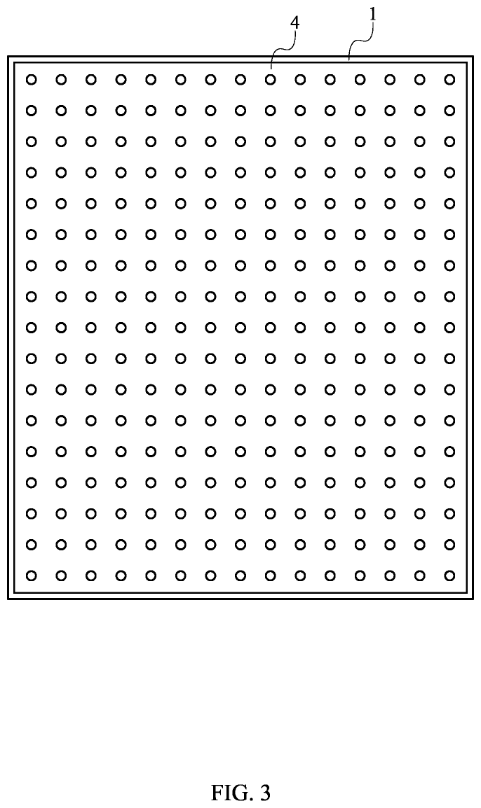

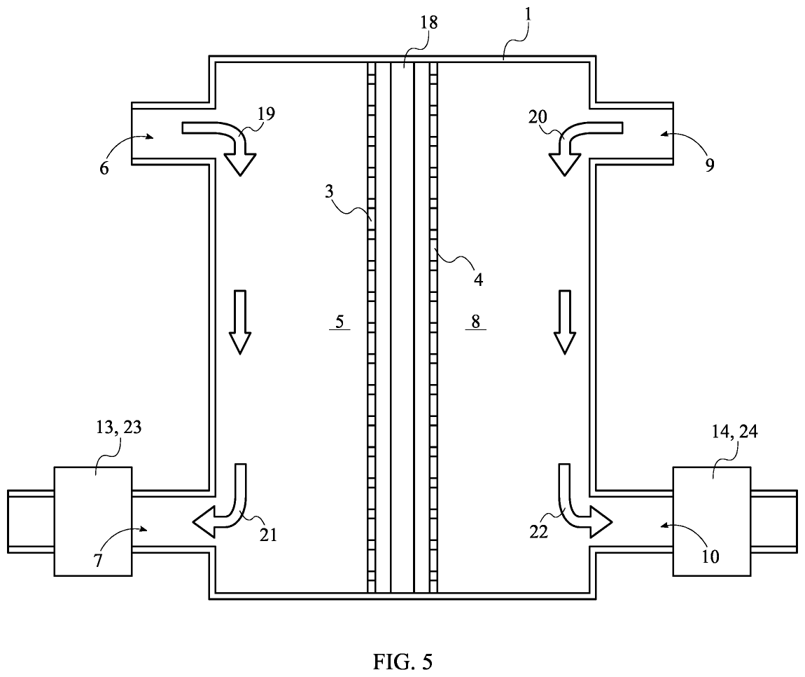

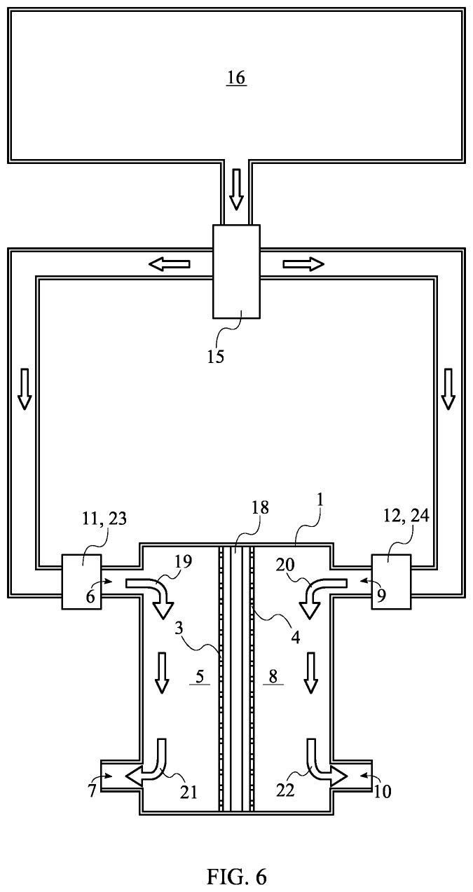

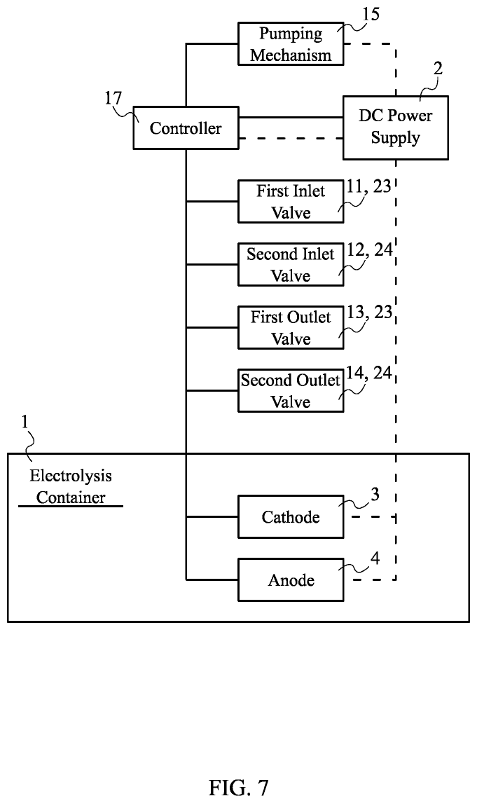

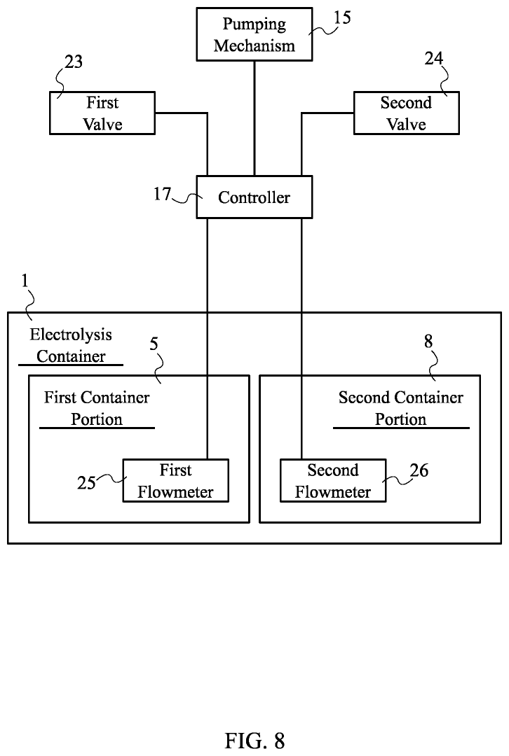

The present invention discloses a system and a method of producing alkaline hydrogen-rich water with acidic oxygen-rich water as byproduct. The present invention enables the production of alkaline hydrogen-rich water in a more efficient and controlled manner. As can be seen in FIGS. 1 through 8, the system of the present invention includes an electrolysis container 1, a direct current (DC) power supply 2, a cathode 3, and an anode 4 (Step A). The electrolysis container 1 corresponds to the structure that houses the cathode 3 and the anode 4 to facilitate the electrolysis process of the present invention. The electrolysis container 1 also guides the flow of source water along the anode 4 and the cathode 3 to enable the electrolysis process. The DC power supply 2 provides the current necessary for the electrolysis process. The cathode 3 and the anode 4 guide the current generated by the DC power supply 2 into the electrolysis container 1 to facilitate the electrolysis process.

Further, as can be seen in FIGS. 1 through 8, to enable the flow of source water through the electrolysis container 1, the electrolysis container 1 includes a first container portion 5, a first container inlet 6, a first container outlet 7, a second container portion 8, a second container inlet 9, a second container outlet 10, and a semipermeable ion-exchange membrane 18. The first container portion 5 and the second container portion 8 correspond to the two internal spaces within the electrolysis container 1 formed by the semipermeable ion-exchange membrane 18. In addition, the first container portion 5 and the second container portion 8 are hermetically separated from each other through the semipermeable ion-exchange membrane 18. Further, the first container inlet 6 and the second container inlet 9 allow source water to flow into the first container portion 5 and the second container portion 8, respectively. On the other hand, the first container outlet 7 and the second container outlet 10 allow source water to flow out of the first container portion 5 and the second container portion 8, respectively. As a result, the first container inlet 6 is in fluid communication with the first container outlet 7 through the first container portion 5 and the second container inlet 9 is in fluid communication with the second container outlet 10 through the second container portion 8. Furthermore, the cathode 3 is positioned within the first container portion 5 while the anode 4 is positioned within the second container portion 8. In addition, the DC power supply 2 is electrically connected between the cathode 3, the anode 4, and the pumping mechanism 15. As a result, as source water flows through the first container portion 5 and the second container portion 8, a portion of source water is exposed to the cathode 3, while the other portion of source water is exposed to the anode 4. Therefore, an electrical path is completed as source water flows through the electrolysis container 1 which enables the electrolysis process to occur simultaneously.

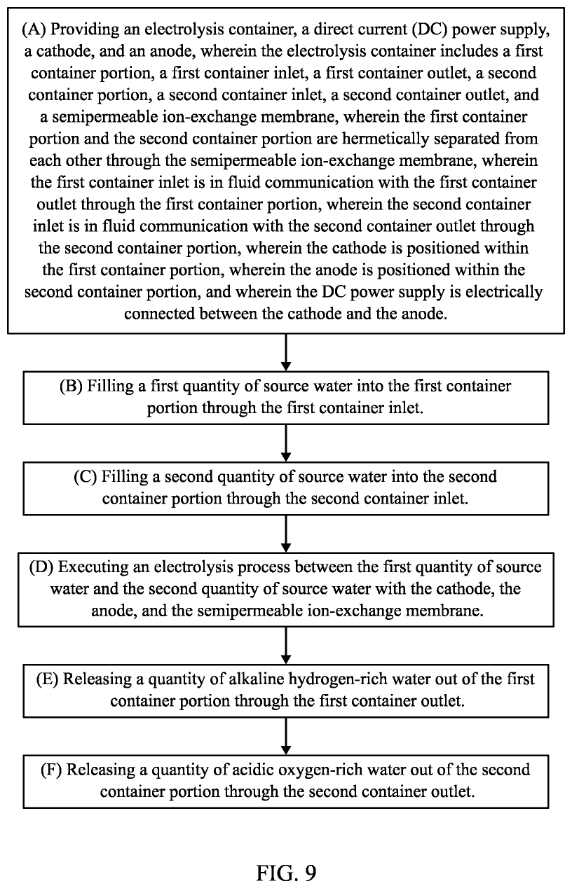

The system of the present invention enables the controlled production of alkaline hydrogen-rich water with acidic oxygen-rich water as byproduct. As can be seen in FIG. 9, the overall process of the method of the present invention begins with a first quantity of source water 19 being filled into the first container portion 5 through the first container inlet 6 (Step B). At the same time, a second quantity of source water 20 is also filled into the second container portion 8 through the second container inlet 9 (Step C). As a result, appropriate amounts of source water constantly flow into the electrolysis container 1 to ensure that the electrolysis process has enough source water to generate the desired amount of alkaline hydrogen-rich water. Further, as source water flows into the electrolysis container 1, an electrolysis process is executed between the first quantity of source water 19 and the second quantity of source water 20 with the cathode 3, the anode 4, and the semipermeable ion-exchange membrane 18 (Step D). During the electrolysis process, H⁺ protons are pulled from the second container portion 8 to the first container portion 5 to form hydrogen gas. Hydrogen gas is dissolved in the first quantity of source water 19 to form alkaline hydrogen-rich water. On the second container portion 8, the oxygen ions left behind form O₂and O₃ gases, which dissolve in the second quantity of source water 20 to form acidic oxygen-rich water as byproduct. After the source water goes through the electrolysis process, a quantity of alkaline hydrogen-rich water 21 is released out of the first container portion 5 through the first container outlet 7 (Step E), while a quantity of acidic oxygen-rich water 22 is released out of the second container portion 8 through the second container outlet 10 (Step F).

The system of the present invention is designed to increase the efficiency of the electrolysis process. As can be seen in FIGS. 1 through 3, the cathode 3 is preferably a perforated flat piece of metal that allows the first quantity of source water 19 to reach the semipermeable ion-exchange membrane 18. In addition, the perforated flat piece of metal is positioned adjacent to and coextensive with the semipermeable ion-exchange membrane 18 to ensure that the largest amount of the first quantity of source water 19 is exposed to the electrolysis process. Similar to the cathode 3, the anode 4 is preferably a perforated flat piece of metal that allows the second quantity of source water 20 to reach the semipermeable ion-exchange membrane 18. In addition, the perforated flat piece of metal is positioned adjacent to and coextensive with the semipermeable ion-exchange membrane 18 to ensure that the largest amount of the second quantity of source water 20 is exposed to the electrolysis process.

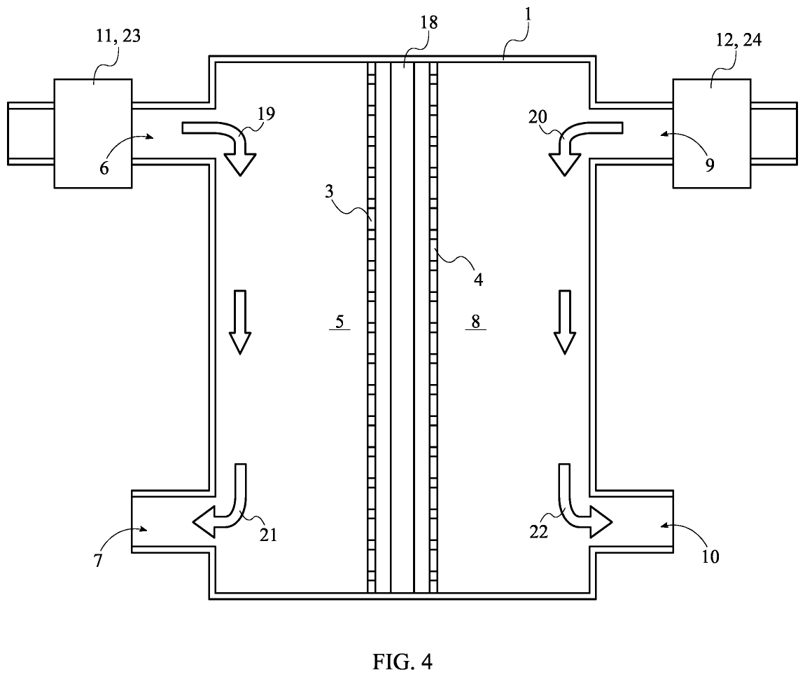

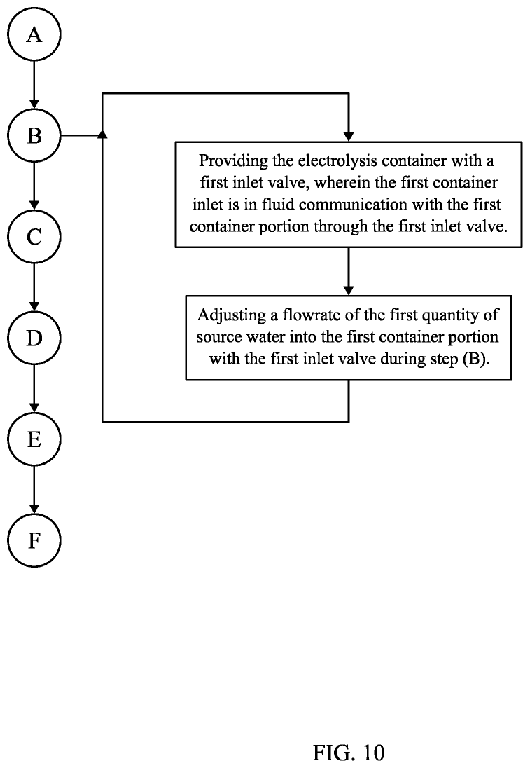

As previously discussed, the present invention enables the selective control of different variables of the electrolysis process enabled by the system of the present invention. In one embodiment, the present invention enables the regulation of the flowrate of the source water flowing into or out of the electrolysis container 1. As can be seen in FIGS. 4 through 6, the electrolysis container 1 can be further provided with a first inlet valve 11. The first container inlet 6 is in fluid communication with the first container portion 5 through the first inlet valve 11 so that the inflow of source water into the first container portion 5 can be selectively adjusted. As can be seen in FIG. 10, the subprocess of adjusting the flowrate of source water through the first inlet valve 11 includes the step of adjusting a flowrate of the first quantity of source water 19 into the first container portion 5 with the first inlet valve 11 during Step B. This way, the system of the present invention enables control of how much source water flows through the first container portion 5. The slower the flowrate of the first quantity of source water 19 into the first container portion 5 and/or with a higher current from the DC power supply 2, the higher the concentration of alkaline hydrogen-rich water produced.

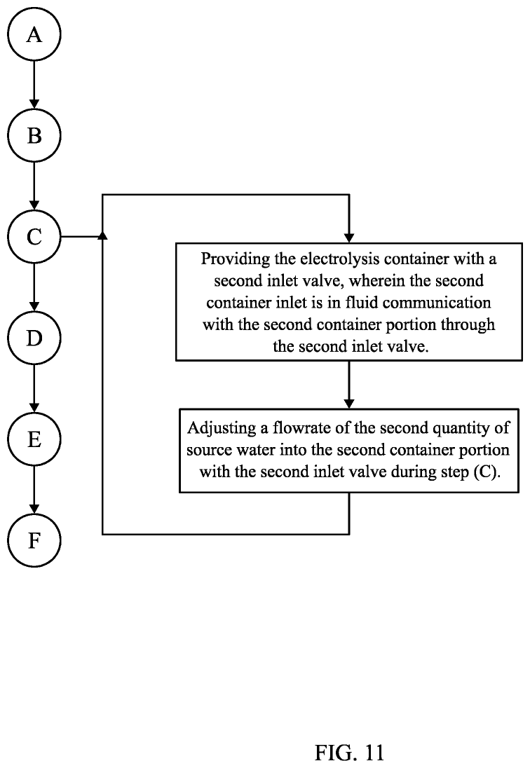

Likewise, the electrolysis container 1 can be further provided with a second inlet valve 12, as can be seen in FIGS. 4 through 6. Like the first inlet valve 11, the second inlet valve 12 enables the regulation of the flowrate of the source water flowing into the second container portion 8. The second container inlet 9 is in fluid communication with the second container portion 8 through the second inlet valve 12 so that the inflow of source water into the second container portion 8 can also be selectively adjusted. As can be seen in FIG. 11, the subprocess of adjusting the flowrate of source water through the second inlet valve 12 includes the step of adjusting a flowrate of the second quantity of source water 20 into the second container portion 8 with the second inlet valve 12 during Step C. This way, the system of the present invention enables control of how much source water flows through the second container portion 8. The slower the flowrate of the second quantity of source water 20 into the second container portion 8 and/or with a higher current from the DC power supply 2, the higher the concentration of acidic oxygen-rich water produced.

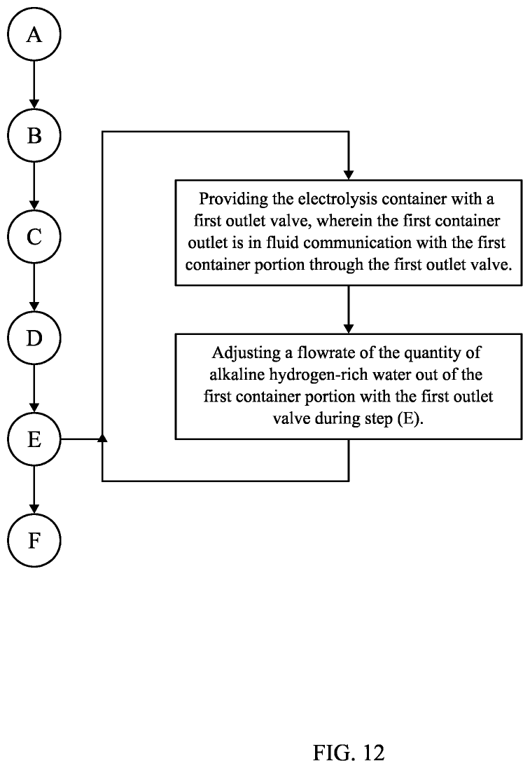

The system of the present invention can also enable the control of the flowrate of produced alkaline hydrogen-rich water and acidic oxygen-rich water released from the electrolysis container 1. As can be seen in FIGS. 4 through 6, the electrolysis container 1 can be further provided with a first outlet valve 13. The first outlet valve 13 enables the flowrate control of alkaline hydrogen-rich water flowing outlet of the first container portion 5. The first container outlet 7 is in fluid communication with the first container portion 5 through the first outlet valve 13 so that the outflow of alkaline hydrogen-rich water out of the first container portion 5 can be selectively adjusted. As can be seen in FIG. 12, the subprocess of adjusting the flowrate of alkaline hydrogen-rich water through the first outlet valve 13 includes the step of flowrate of the quantity of alkaline hydrogen-rich water 21 out of the first container portion 5 with the first outlet valve 13 during Step E. This way, the system of the present invention enables control of how much source water flows through the first container portion 5. The slower the flowrate of the first quantity of source water 19 into the first container portion 5 and/or with a higher current from the DC power supply 2, the higher the concentration of alkaline hydrogen-rich water produced.

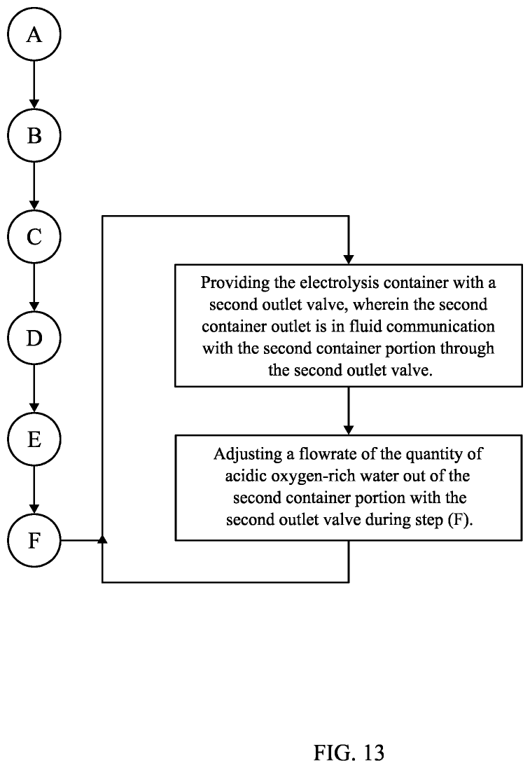

Likewise, the electrolysis container 1 can be further provided with a second outlet valve 14, as can be seen in FIGS. 4 through 6. The second outlet valve 14 enables the flowrate control of acidic oxygen-rich water flowing out of the second container portion 8. The second container outlet 10 is in fluid communication with the second container portion 8 through the second outlet valve 14 so that the outlet of acidic oxygen-rich water out of the second container portion 8 can also be selectively adjusted. As can be seen in FIG. 13, the subprocess of adjusting the flowrate of acidic oxygen-rich water through the second outlet valve 14 includes the step of adjusting a flowrate of the quantity of acidic oxygen-rich water 22 out of the second container portion 8 with the second outlet valve 14 during Step F. This way, the system of the present invention enables control of how much source water flows through the second container portion 8. The slower the flowrate of the second quantity of source water 20 into the second container portion 8 and/or with a higher current from the DC power supply 2, the higher the concentration of acidic oxygen-rich water produced.

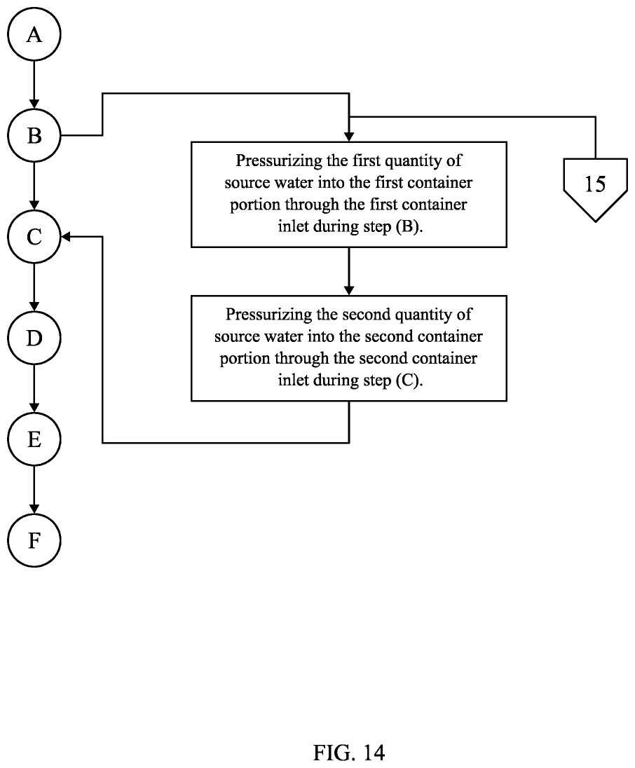

The present invention enables the flow of source water from a single supply into the electrolysis container 1 in a pressurized manner. As can be seen in FIG. 14, the first quantity of source water can be pressurized into the first container portion through the first container inlet during Step B. Similarly, the second quantity of source water is pressurized into the second container portion through the second container inlet during Step C. Pressurizing the source water enables a greater amount of water to flow into the electrolysis container 1 in a shorter amount of time. For example, the source water can be guided from an elevated source of water, and the source water can be guided through various conduits into the first container inlet 6 and the second container inlet 9 via gravity. However, different mechanisms can be utilized to pressurize the source water flows into the first container inlet 6 and the second container inlet 9.

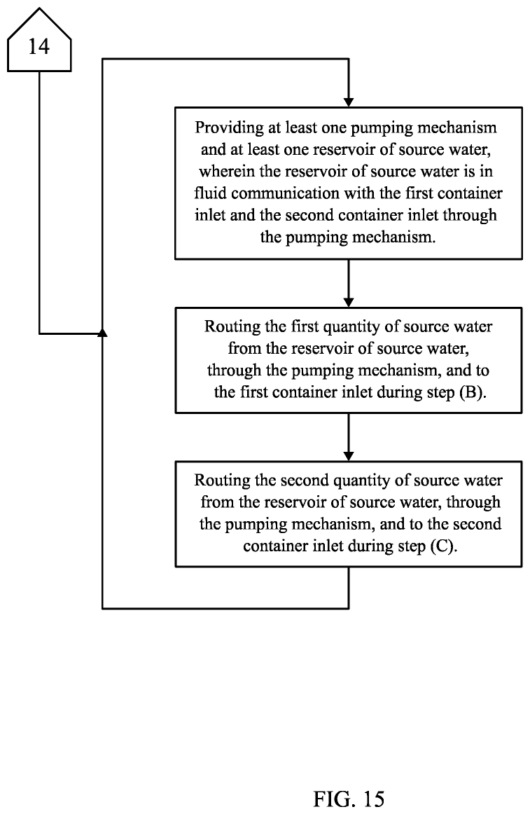

As can be seen in FIGS. 4 through 7, in some embodiments, the system of the present invention may further include at least one pumping mechanism 15 and at least one reservoir of source water 16 that help deliver source water into the electrolysis container 1 in a pressurized manner. The reservoir of source water 16 retains the necessary amount of source water for the system of the present invention to produce the desired amount of alkaline hydrogen-rich water. The pumping mechanism 15 allows for the source water to be pressurized to create a water flow, in the absence of pressurized water source or pressurized water from reservoir located high above the system, into the first container portion 5 and the second container portion 8. To do so, the reservoir of source water 16 is in fluid communication with the first container inlet 6 and the second container inlet 9 through the pumping mechanism 15. As can be seen in FIG. 15, the subprocess of pressurizing source water from the reservoir of source water 16 into the electrolysis container 1 includes the steps of routing the first quantity of source water 19 from the reservoir of source water 16, through the pumping mechanism 15, and to the first container inlet 6 during Step B. This way, the first quantity of source water 19 is pressurized before flowing into the first container portion 5. Simultaneously, the second quantity of source water 20 is also routed from the reservoir of source water 16, through the pumping mechanism 15, and to the second container inlet 9 during Step C. This way, the second quantity of source water 20 is also pressurized to create a water flow through the second container portion 8.

The system of the present invention enables direct control of the first inlet valve 11 and the first outlet valve 13 so that the appropriate user can manually control the flowrate of source water flowing through the first container portion 5. In other embodiments, the present invention can also enable the electronic control of the first inlet valve 11 and the first outlet valve 13. As can be seen in FIGS. 4 through 8, the system of the present invention can further include a controller 17 and a first valve 23 that enable the appropriate user to electronically regulate a flowrate from the first container inlet 6, through the first container portion 5, and out of the first container outlet 7. The first valve 23 can correspond to either the first inlet valve 11, the first outlet valve 13, or both. In addition, the controller 17 is electronically connected to the first valve 23 so that the appropriate operational command signals can be transmitted to the first inlet valve 11 and/or the first outlet valve 13. In some embodiments of the present invention, the electronic control of the first inlet valve 11 and/or the first outlet valve 13 may be controlled via analog control signal, digital control signal, or a combination of analog and digital control.

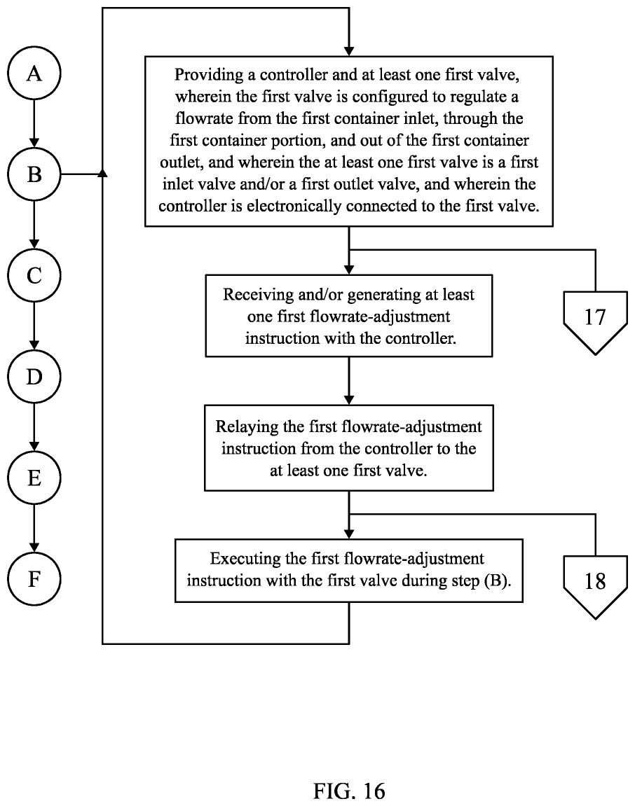

As can be seen in FIG. 16, the subprocess of controlling the first valve 23 via a controller 17 includes the steps of receiving and/or generating at least one first flowrate-adjustment instruction with the controller 17. The controller 17 may include a User Interface (UI) that enables the appropriate user to directly input the operational command signals. Alternatively, the controller 17 may be communicably coupled to an external computing device such as a portable computing device from which the appropriate user can relay the operational command signals. Next, the first flowrate-adjustment instruction is relayed from the controller 17 to the at least one first valve 23. In other words, the first flowrate-adjustment instruction can include operational commands for the first valve 23. Next, the first flowrate-adjustment instruction is executed with the first valve 23 during Step B, depending on the operational commands in the first flowrate-adjustment instruction. As a result, the appropriate user can dynamically control the flowrate of source water through the first container portion 5.

As can be seen in FIGS. 4 through 8, the first flowrate-adjustment instruction can be generated based on data gathered from the first container portion 5 regarding the current flowrate through the first container portion 5. To do so, the system of the present invention may further comprise at least one first flowmeter 25. The first flowmeter 25 is configured to measure the flowrate from the first container inlet 6, through the first container portion 5, and out of the first container outlet 7, to help provide the data necessary to regulate the flowrate of source water through the first container portion 5. In addition, the controller 17 is electronically connected to the first flowmeter 25 to receive the data signals generated by the first flowmeter 25. The first flowmeter 25 may be used in conjunction with the first inlet valve 11, the first outlet valve 13, and the controller 17 for close loop control of the flowrate. The first flowmeter 25 may be placed adjacent to the first container inlet 6 or the first container outlet 7 to determine water flowrate inside the first container portion 5 at any given moment.

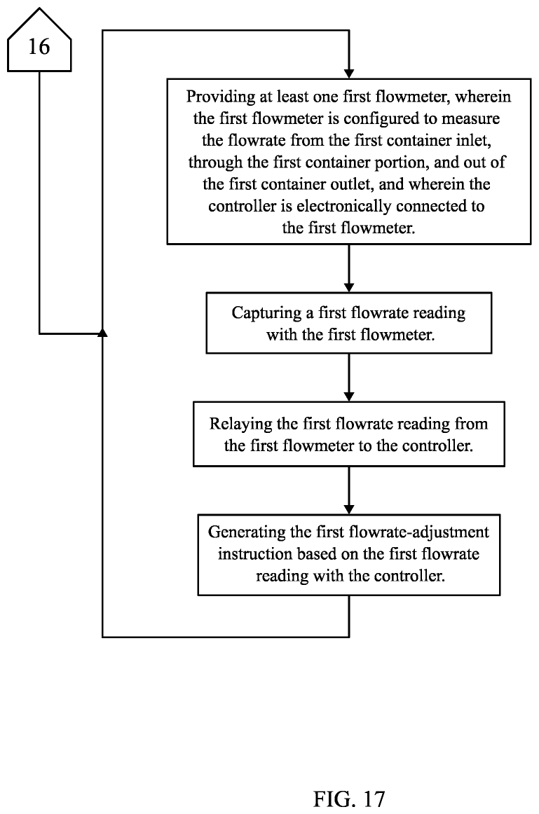

As can be seen in FIG. 17, the subprocess of capturing flowrate data with the first flowmeter 25 begins by capturing a first flowrate reading with the first flowmeter 25. The first flowrate reading includes data regarding the current flowrate through the first container portion 5. Next, the first flowrate reading is relayed from the first flowmeter 25 to the controller 17 to provide the controller 17 with the data necessary to generate the first flowrate-adjustment instruction. Next, the first flowrate-adjustment instruction based on the first flowrate reading is generated with the controller 17. As a result, a closed feedback loop for the first container portion 5 is created.

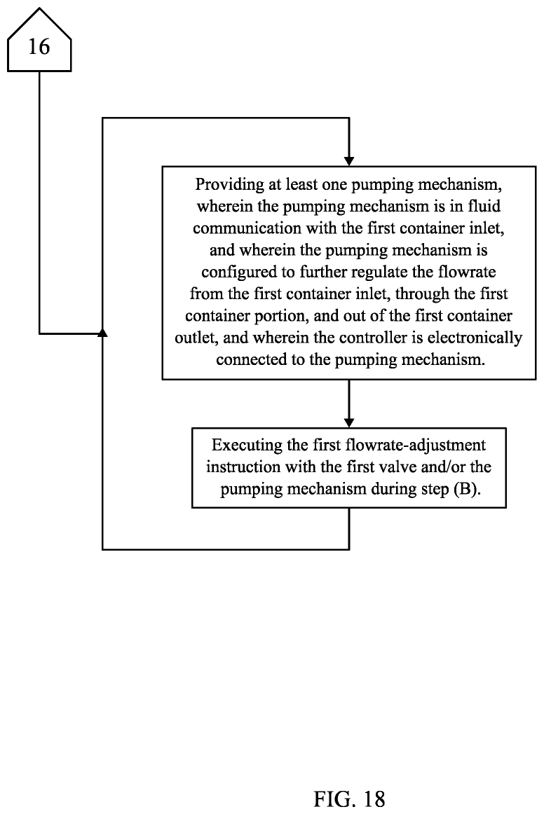

In addition to controlling the first valve 23 via the controller 17, the system of the present invention also enables the appropriate user to control the pumping mechanism 15 via the controller 17, as can be seen in FIGS. 4 through 8. This enables the appropriate user to adjust the flowrate of the first quantity of source water 19 flowing from the first container inlet 6, through the first container portion 5, and out of the first container outlet 7. To do so, the controller 17 is electronically connected to the pumping mechanism 15 so that the appropriate operational command signals can also be transmitted to the pumping mechanism 15. As can be seen in FIG. 18, the subprocess of controlling the pumping mechanism 15 via the controller 17 includes the step executing the first flowrate-adjustment instruction with the first valve 23 and/or the pumping mechanism 15 during Step B. As a result, the appropriate user can dynamically control the flowrate of the first quantity of source water 19. In some embodiments, the pumping mechanism 15 may be powered by the DC power supply 2.

The system of the present invention enables direct control of the second inlet valve 12 and the second outlet valve 14 so that the appropriate user can manually control the flowrate of source water flowing through the second container portion 8. In other embodiments, the present invention can also enable the electronic control of the second inlet valve 12 and the first outlet valve 14. As can be seen in FIGS. 4 through 8, the system of the present invention can further include a controller 17 and a second valve 24 that enable the appropriate user to electronically regulate a flowrate from the second container inlet 9, through the first container portion 8, and out of the first container outlet 10. The second valve 24 can correspond to either the second inlet valve 12, the second outlet valve 14, or both. In addition, the controller 17 is electronically connected to the second valve 24 so that the appropriate operational command signals can be transmitted to the second inlet valve 12 and/or the first outlet valve 14. In some embodiments of the present invention, the electronic control of the second inlet valve 12 and/or the second outlet valve 14 may be controlled via analog control signal, digital control signal, or a combination of analog and digital control.

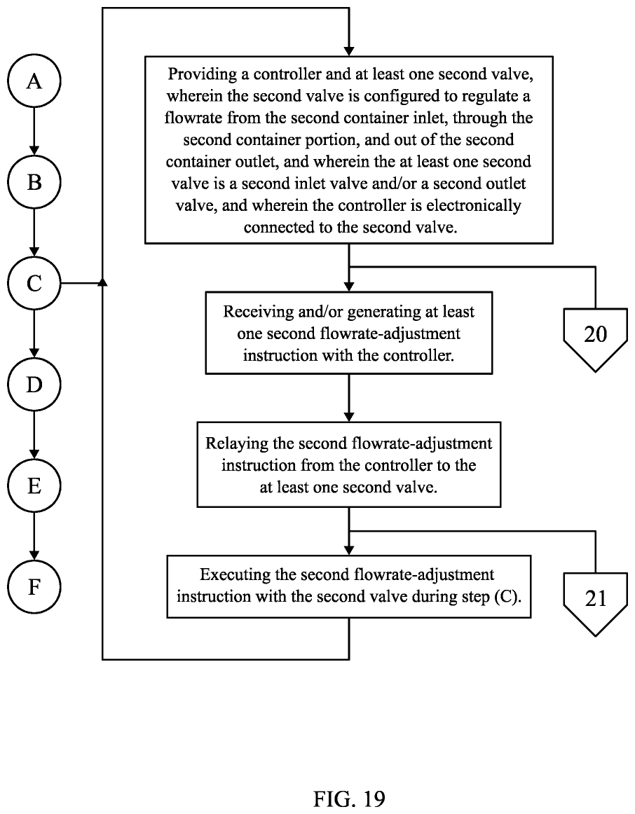

As can be seen in FIG. 19, the subprocess of controlling the second valve 24 via a controller 17 includes the steps of receiving and/or generating at least one second flowrate-adjustment instruction with the controller 17. Next, the second flowrate-adjustment instruction is relayed from the controller 17 to the at least one second valve 24. In other words, the second flowrate-adjustment instruction can include operational commands for the second valve 24. Next, the second flowrate-adjustment instruction is executed with the second valve 24 during Step C, depending on the operational commands in the second flowrate-adjustment instruction. As a result, the appropriate user can dynamically control the flowrate of source water through the second container portion 8.

As can be seen in FIGS. 4 through 8, the second flowrate-adjustment instruction can be generated based on data gathered from the second container portion 8 regarding the current flowrate through the second container portion 8. To do so, the system of the present invention may further comprise at least one second flowmeter 26. The second flowmeter 26 is configured to measure the flowrate from the second container inlet 9, through the second container portion 8, and out of the second container outlet 10, to help provide the data necessary to regulate the flowrate of source water through the second container portion 8. In addition, the controller 17 is electronically connected to the second flowmeter 26 to receive the data signals generated by the second flowmeter 26. The second flowmeter 26 may be used in conjunction with the second inlet valve 12, the second outlet valve 14, and the controller 17 for close loop control of the flowrate. The second flowmeter 26 may be placed adjacent to the second container inlet 9 or the second container outlet 10 to determine water flowrate inside the second container portion 8 at any given moment.

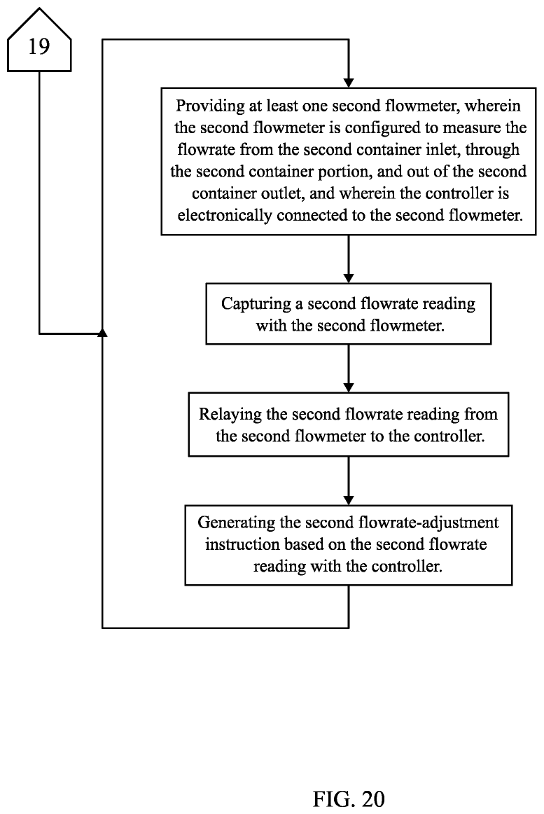

As can be seen in FIG. 20, the subprocess of capturing flowrate data with the second flowmeter 26 begins by capturing a second flowrate reading with the second flowmeter 26. The second flowrate reading includes data regarding the current flowrate through the second container portion 8. Next, the second flowrate reading is relayed from the second flowmeter 26 to the controller 17 to provide the controller 17 with the data necessary to generate the second flowrate-adjustment instruction. Next, the second flowrate-adjustment instruction based on the second flowrate reading is generated with the controller 17. As a result, a closed feedback loop for the second container portion 8 is created.

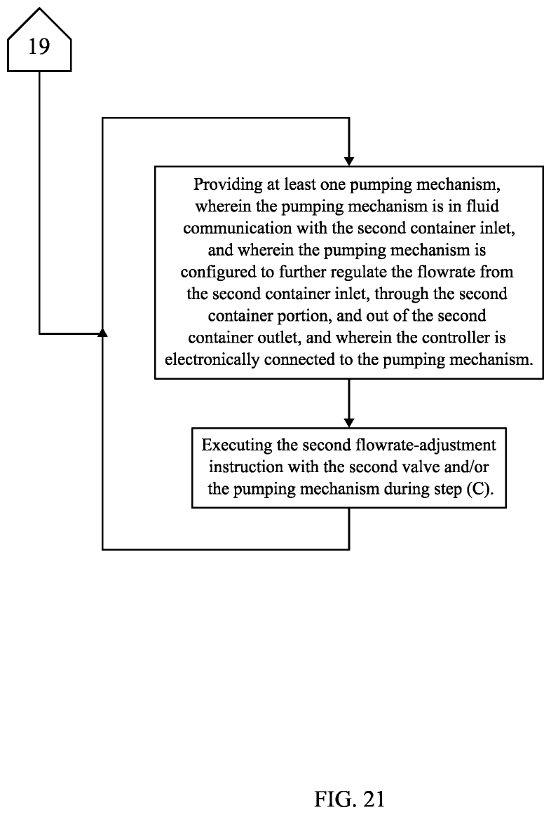

In addition to controlling the second valve 24 via the controller 17, the system of the present invention also enables the appropriate user to control the pumping mechanism 15 via the controller 17, as can be seen in FIGS. 4 through 8. This enables the appropriate user to adjust the flowrate of the second quantity of source water 20 flowing from the second container inlet 9, through the second container portion 8, and out of the second container outlet 10. To do so, the controller 17 is electronically connected to the pumping mechanism 15 so that the appropriate operational command signals can also be transmitted to the pumping mechanism 15. As can be seen in FIG. 21, the subprocess of controlling the pumping mechanism 15 via the controller 17 includes the step executing the second flowrate-adjustment instruction with the second valve 24 and/or the pumping mechanism 15 during Step C. As a result, the appropriate user can dynamically control the flowrate of the second quantity of source water 20. In some embodiments, the pumping mechanism 15 may be powered by the DC power supply 2.

In addition to controlling the inflow of source water into the electrolysis container 1 and the outflow of produced alkaline hydrogen-rich water and the acidic oxygen-rich water out of the electrolysis container 1, the present invention can also enable the appropriate user to control the pH level and the concentration of hydrogen in the produced alkaline hydrogen-rich water. As can be seen in FIGS. 4 through 8, the controller 17 is electronically connected to the DC power supply 2 in order to enable the control of the current supplied to the electrolysis system for the execution of the electrolysis process. The pH level and the concentration of hydrogen in the produced alkaline hydrogen-rich water is directly affected by the current applied to the electrolysis system. As can be seen in FIG. 21, the subprocess of controlling the DC power supply 2 via the controller 17 includes the steps of receiving and/or generating at least one current-adjustment instruction with the controller 17. As previously discussed, the current-adjustment instruction can be generated on the controller 17 or transmitted to the controller 17 from an external computing device. Next, the current-adjustment instruction is relayed from the controller 17 to the DC power supply 2 to enable the execution of the current-adjustment instruction. Next, the current-adjustment instruction is executed with the DC power supply 2 during Step D. As a result, the appropriate user can control the pH level and the concentration of hydrogen in the produced alkaline hydrogen-rich water by controlling the current applied by the DC power supply 2.

As previously discussed, the produced alkaline hydrogen-rich water can be used to treat different physical ailments due to the health benefits from drinking produced alkaline hydrogen-rich water. For example, the produced alkaline hydrogen-rich water can be used to reduce inflammation in muscle tissue and/or nerve tissue, reduce systematic inflammation and/or treat an autoimmune disease (e.g., multiple sclerosis, Parkinson's disease, Alzheimer's disease, brain injuries, strokes, Crohn's disease, rheumatoid arthritis, etc.), treat glaucoma or radiation exposure, increase libido, reduce muscle fatigue, improve mental alertness, prevent crystallization of uric acid, prevent cancer. In addition, the produced alkaline hydrogen-rich water can help reduce blood glucose and counteract the effects of radiation on the body. In other embodiments, the produced alkaline hydrogen-rich water can be used to treat different physical ailments that may benefit from more efficient water absorption by different body cells.

Although the invention has been explained in relation to its preferred embodiment, it is to be understood that many other possible modifications and variations can be made without departing from the spirit and scope of the invention.

What is claimed is:

1. A method of producing alkaline hydrogen-rich water with acidic oxygen-rich water as byproduct, the method comprising the steps of:
(A) providing an electrolysis container, a direct current (DC) power supply, a cathode, and an anode, wherein the electrolysis container includes a first container portion, a first container inlet, a first container outlet, a second container portion, a second container inlet, a second container outlet, and a semipermeable ion-exchange membrane, wherein the first container portion and the second container portion are hermetically separated from each other through the semipermeable ion-exchange membrane, wherein the first container inlet is in fluid communication with the first container outlet through the first container portion, wherein the second container inlet is in fluid communication with the second container outlet through the second container portion, wherein the cathode is positioned within the first container portion, wherein the anode is positioned within the second container portion, and wherein the DC power supply is electrically connected between the cathode and the anode;
(B) filling the first container portion with a first quantity of source water through the first container inlet;
(C) filling the second container portion with a second quantity of source water through the second container inlet;
(D) executing an electrolysis process between the first quantity of source water and the second quantity of source water with the cathode, the anode, and the semipermeable ion-exchange membrane;
(E) releasing a quantity of alkaline hydrogen-rich water out of the first container portion through the first container outlet; and
(F) releasing a quantity of acidic oxygen-rich water out of the second container portion through the second container outlet.

2. The method as claimed in claim 1, wherein the cathode is a perforated flat piece of metal, and wherein the perforated flat piece of metal is positioned adjacent to and coextensive with the semipermeable ion-exchange membrane.

3. The method as claimed in claim 1, wherein the anode is a perforated flat piece of metal, and wherein the perforated flat piece of metal is positioned adjacent to and coextensive with the semipermeable ion-exchange membrane.

4. The method as claimed in claim 1 comprising the steps of:
providing the electrolysis container with a first inlet valve, wherein the first container inlet is in fluid communication with the first container portion through the first inlet valve; and
adjusting a flowrate of the first quantity of source water into the first container portion with the first inlet valve during step (B).

5. The method as claimed in claim 1 comprising the steps of:
providing the electrolysis container with a second inlet valve, wherein the second container inlet is in fluid communication with the second container portion through the second inlet valve; and
adjusting a flowrate of the second quantity of source water into the second container portion with the second inlet valve during step (C).

6. The method as claimed in claim 1 comprising the steps of:
providing the electrolysis container with a first outlet valve, wherein the first container outlet is in fluid communication with the first container portion through the first outlet valve; and
adjusting a flowrate of the quantity of alkaline hydrogen-rich water out of the first container portion with the first outlet valve during step (E).

7. The method as claimed in claim 1 comprising the steps of:
providing the electrolysis container with a second outlet valve, wherein the second container outlet is in fluid communication with the second container portion through the second outlet valve; and
adjusting a flowrate of the quantity of acidic oxygen-rich water out of the second container portion with the second outlet valve during step (F).

8. The method as claimed in claim 1 comprising the steps of:
pressurizing the first quantity of source water into the first container portion through the first container inlet during step (B); and
pressurizing the second quantity of source water into the second container portion through the second container inlet during step (C).

9. The method as claimed in claim 8 comprising the steps of:
providing at least one pumping mechanism and at least one reservoir of source water, wherein the reservoir of source water is in fluid communication with the first container inlet and the second container inlet through the pumping mechanism;
routing the first quantity of source water from the reservoir of source water, through the pumping mechanism, and to the first container inlet during step (B); and
routing the second quantity of source water from the reservoir of source water, through the pumping mechanism, and to the second container inlet during step (C).

10. The method as claimed in claim 1 comprising the steps of:
providing a controller and at least one first valve, wherein the first valve is configured to regulate a flowrate from the first container inlet, through the first container portion, and out of the first container outlet, and wherein the at least one first valve is a first inlet valve and/or a first outlet valve, and wherein the controller is electronically connected to the first valve;
receiving and/or generating at least one first flowrate-adjustment instruction with the controller;
relaying the first flowrate-adjustment instruction from the controller to the at least one first valve; and
executing the first flowrate-adjustment instruction with the first valve during step (B).

11. The method as claimed in claim 10 comprising the steps of:
providing at least one first flowmeter, wherein the first flowmeter is configured to measure the flowrate from the first container inlet, through the first container portion, and out of the first container outlet, and wherein the controller is electronically connected to the first flowmeter;
capturing a first flowrate reading with the first flowmeter;
relaying the first flowrate reading from the first flowmeter to the controller; and
generating the first flowrate-adjustment instruction based on the first flowrate reading with the controller.

12. The method as claimed in claim 10 comprising the steps of:
providing at least one pumping mechanism, wherein the pumping mechanism is in fluid communication with the first container inlet, and wherein the pumping mechanism is configured to further regulate the flowrate from the first container inlet, through the first container portion, and out of the first container outlet, and wherein the controller is electronically connected to the pumping mechanism; and
executing the first flowrate-adjustment instruction with the first valve and/or the pumping mechanism during step (B).

13. The method as claimed in claim 1 comprising the steps of:
providing a controller and at least one second valve, wherein the second valve is configured to regulate a flowrate from the second container inlet, through the second container portion, and out of the second container outlet, and wherein the at least one second valve is a second inlet valve and/or a second outlet valve, and wherein the controller is electronically connected to the second valve;
receiving and/or generating at least one second flowrate-adjustment instruction with the controller;
relaying the second flowrate-adjustment instruction from the controller to the at least one second valve; and
executing the second flowrate-adjustment instruction with the second valve during step (C).

14. The method as claimed in claim 13 comprising the steps of:
providing at least one second flowmeter, wherein the second flowmeter is configured to measure the flowrate from the second container inlet, through the second container portion, and out of the second container outlet, and wherein the controller is electronically connected to the second flowmeter;
capturing a second flowrate reading with the second flowmeter;
relaying the second flowrate reading from the second flowmeter to the controller; and
generating the second flowrate-adjustment instruction based on the second flowrate reading with the controller.

15. The method as claimed in claim 13 comprising the steps of:
providing at least one pumping mechanism, wherein the pumping mechanism is in fluid communication with the second container inlet, and wherein the pumping mechanism is configured to further regulate the flowrate from the second container inlet, through the second container portion, and out of the second container outlet, and wherein the controller is electronically connected to the pumping mechanism; and
executing the second flowrate-adjustment instruction with the second valve and/or the pumping mechanism during step (C).

16. The method as claimed in claim 1 comprising the steps of:
providing a controller, wherein the controller is electronically connected to the DC power supply;
receiving and/or generating at least one current-adjustment instruction with the controller;
relaying the current-adjustment instruction from the controller to the DC power supply; and
executing the current-adjustment instruction with the DC power supply during step (D).

17. The method as claimed in claim 1, wherein the quantity of alkaline hydrogen-rich water is used to reduce inflammation in muscle tissue and/or nerve tissue.

18. The method as claimed in claim 1, wherein the quantity of alkaline hydrogen-rich water is used to reduce systematic inflammation and/or treat an autoimmune disease.

19. The method as claimed in claim 1, wherein the quantity of alkaline hydrogen-rich water is used to treat glaucoma or radiation exposure.

20. The method as claimed in claim 1, wherein the quantity of alkaline hydrogen-rich water is used to increase libido.

21. The method as claimed in claim 1, wherein the quantity of alkaline hydrogen-rich water is used to reduce muscle fatigue.

22. The method as claimed in claim 1, wherein the quantity of alkaline hydrogen-rich water is used to improve mental alertness.

23. The method as claimed in claim 1, wherein the quantity of alkaline hydrogen-rich water is used to prevent crystallization of uric acid.

24. The method as claimed in claim 1, wherein the quantity of alkaline hydrogen-rich water as a super antioxidant is used to prevent cancer.
